(19) United States
(12) Patent Application Publication
(10) Pub. No.: US 2008/0153572 A1
(43) Pub. Date: Jun. 26, 2008

(54) SLOT MACHINE INCLUDING MULTIPLE SLOT GAME AREAS AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/953,247

(22) Filed: Dec. 10, 2007

(30) Foreign Application Priority Data
Dec. 14, 2006 (JP) 2006-337297

(51) Int. Cl. A63F 13/00; A63F 9/24

(52) U.S. Cl. 463/20

(57) ABSTRACT

Multiple slot game areas are provided on a liquid crystal display. Among the respective slot game areas, the areas to be activated are determined in accordance either with a number of bet credits or with a number of inserted medals. Slot games are executed in the activated slot game areas. When payouts are generated in some of the slot games, a total amount of these payouts is provided.

### CROSS REFERENCE TO RELATED APPLICATIONS

This application is based upon and claims the benefit of priority from the prior Japanese Patent Application No. 2006-337297, filed on Dec. 14, 2006, the entire contents of which are incorporated herein by reference.

### BACKGROUND OF THE INVENTION

1. Field of the Invention

The present invention relates to a slot machine and a method of playing a slot machine.

2. Description of the Related Art

In the related slot machine, multiple (three, for example) reels on each of which multiple symbols are drawn individually rotate when a player inserts a predetermined number of medals into a medal insertion slot and operates a start button. Thereafter, the reels are stopped after a predetermined period of time. At this time, if symbols satisfying a winning combination or a predetermined number of scatter symbols are stopped on a preset payline, a payout based on the number of inserted medals is generated.

Meanwhile, U.S. Pat. No. 6,855,052 discloses a configuration to cause multiple wheels provided above reels to start spinning sequentially and then to stop spinning in the case where symbols displayed on the reels being stopped satisfy a preset combination, and then to generate a payout of many medals in the case where stop positions of the wheels satisfies preset stop positions.

In this way, there has been a demand for providing a slot machine which is configured to pay out such a large number of medals that have been unobtainable in one slot game instead of executing just one slot game upon insertion of medals.

### SUMMARY OF THE INVENTION

The present invention has been made to solve the above-described problem of the conventional technique. An object of the present invention is to provide a slot machine and a method of playing a slot machine capable of improving entertainment values.

The first aspect of the present invention is a slot machine comprising: a display having a plurality of slot game areas for executing a slot game of rearranging a plurality of arranged symbols in each of the slot game areas; an input device configured to read a bet of a credit by a player; and a controller configured to activate a slot game area corresponding to the bet read by the input device out of the plurality of slot game areas, to execute the slot game in the activated slot game area, and to provide a payout corresponding to an outcome of a play of each executed slot game.

The second aspect of the present invention is a slot machine comprising: a display having a plurality of slot game areas for playing a slot game of rearranging a plurality of arranged symbols in each of the slot game areas; an input device configured to read a bet of a credit by a player; and a controller configured to activate slot game areas corresponding to the bet read by the input device out of the plurality of slot game areas, and when outcomes of plays of some of the slot games out of the slot games executed in the activated slot game areas deserve provision of payouts, to provide a total amount of the payouts of the respective slot games.

The third aspect of the present invention is a slot machine comprising: a display having a plurality of slot game areas for executing a slot game by rearranging a plurality of arranged symbols in each of the slot game areas; an input device configured to read a bet of a credit by a player; and a controller configured to activate slot game areas corresponding to the bet read by the input device out of the plurality of slot game areas, and when outcomes of plays of some of the slot games out of the slot games executed in the activated slot gale areas deserve provision of payouts, to provide a total amount of the payouts in the respective slot games, and to provide a special payout amount in addition to the total amount of the payouts when the total amount of the payouts reaches a predetermined amount.

The fourth aspect of the present invention is a method of playing a slot machine comprising: making a bet of a credit; activating a slot game area in accordance with the bet out of a plurality of slot game areas for executing a slot game of rearranging a plurality of arranged symbols in each of the slot game areas; executing the slot game in the activated slot game area; and providing a payout corresponding to an outcome of a play in each slot game executed in the activated slot game area.

The fifth aspect of the present invention is a method of playing a slot machine comprising: making a bet of an arbitrary number of credits; activating slot game areas in accordance with the bet out of a plurality of slot game areas for executing a slot game of rearranging a plurality of arranged symbols in each of the slot game areas; executing the slot games in the activated slot game areas; and when outcomes of plays of some of the slot games executed in the activated slot game areas deserve provision of payouts, providing a total amount of the payouts of the respective slot games.

The sixth aspect of the present invention is a method of playing a slot machine comprising: making a bet of an arbitrary number of credits; activating slot game areas in response to the bet out of a plurality of slot game areas for executing a slot game by rearranging a plurality of arranged symbols in each of the slot game areas; executing the slot games in the activated slot game areas; when outcomes of plays of some of the slot games executed in the activated slot game areas deserve provision of payouts, providing a total amount of the payouts of the respective slot games; and providing a special payout amount in addition to the total amount of the payouts when the total amount of the payouts reaches a predetermined amount.

According to above-described aspects, which and how many slot game areas are activated out of the multiple slot game areas depend on how many credits are bet. Moreover, a payout is generated on the basis of the outcomes of the slot games executed in the activated slot game areas. Therefore, it is possible to allow a player to play multiple slot games in one play session and thereby to offer, to the player, an expectation for a large payout.

The preset invention is also useful for enhancing motivation of a player for playing games.

### BRIEF DESCRIPTION OF THE DRAWINGS

FIG. 1 is an explanatory view showing ten slot game areas displayed on a liquid crystal display of a slot machine according to an embodiment of the present invention.

FIG. 2 is a perspective view of the slot machine according to the embodiment of the present invention.

FIG. 3 is a block diagram showing a control circuit of the slot machine according to the embodiment of the present invention.

FIG. 4 is a flowchart showing procedures of the slot machine according to the embodiment of the present invention.

FIG. 5 is another flowchart showing the procedures of the slot machine according to the embodiment of the present invention.

FIG. 6 is another flowchart showing the procedures of the slot machine according to the embodiment of the present invention.

FIG. 7 is another flowchart showing the procedures of the slot machine according to the embodiment of the present invention.

FIG. 8 is another flowchart showing the procedures of the slot machine according to the embodiment of the present invention.

FIG. 9 is another flowchart showing the procedures of the slot machine according to the embodiment of the present invention.

FIG. 10 is another flowchart showing the procedures of the slot machine according to the embodiment of the present invention.

FIG. 11 is another flowchart showing the procedures of the slot machine according to the embodiment of the present invention.

FIG. 12 is an explanatory view showing slot game areas of the slot machine according to the embodiment of the present invention.

FIG. 13 is an explanatory view showing paylines in the respective slot game areas of the slot machine according to the embodiment of the present invention.

FIG. 14 is an explanatory view of a payout table showing relations between winning combinations and payouts applicable to the slot machine according to the embodiment of the present invention.

FIG. 15 is another explanatory view showing the respective slot game areas displayed on the liquid crystal display of the slot machine according to the embodiment of the present invention.

FIG. 16 is an explanatory view showing the respective slot game areas displayed on the liquid crystal display of the slot machine according to the embodiment of the present invention.

FIG. 17 is an explanatory view showing the respective slot game areas displayed on the liquid crystal display of the slot machine according to the embodiment of the present invention.

FIG. 18 is an explanatory view showing relations of numbers of bet credits and bet areas which shows bets in the case when an area A8 is in the course of a bonus game.

### DETAILED DESCRIPTION OF THE EMBODIMENT

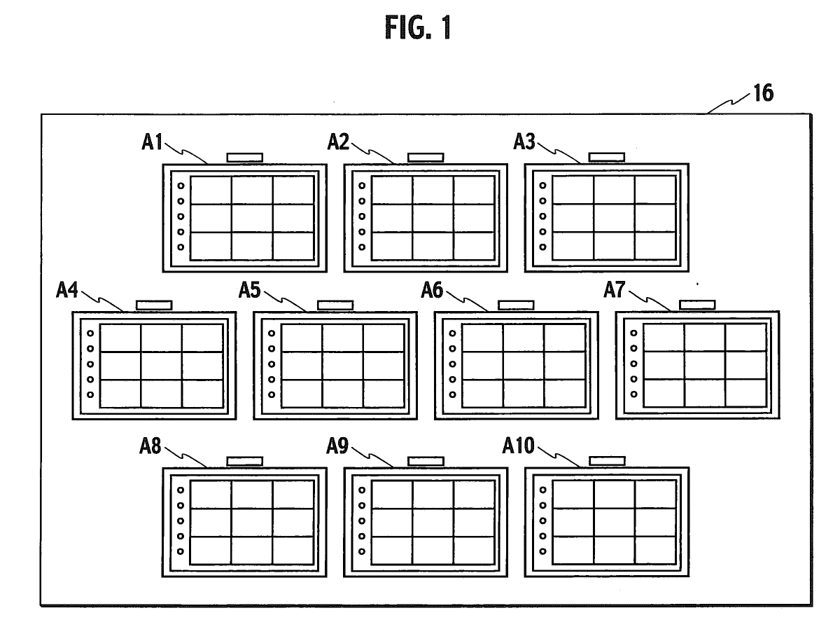

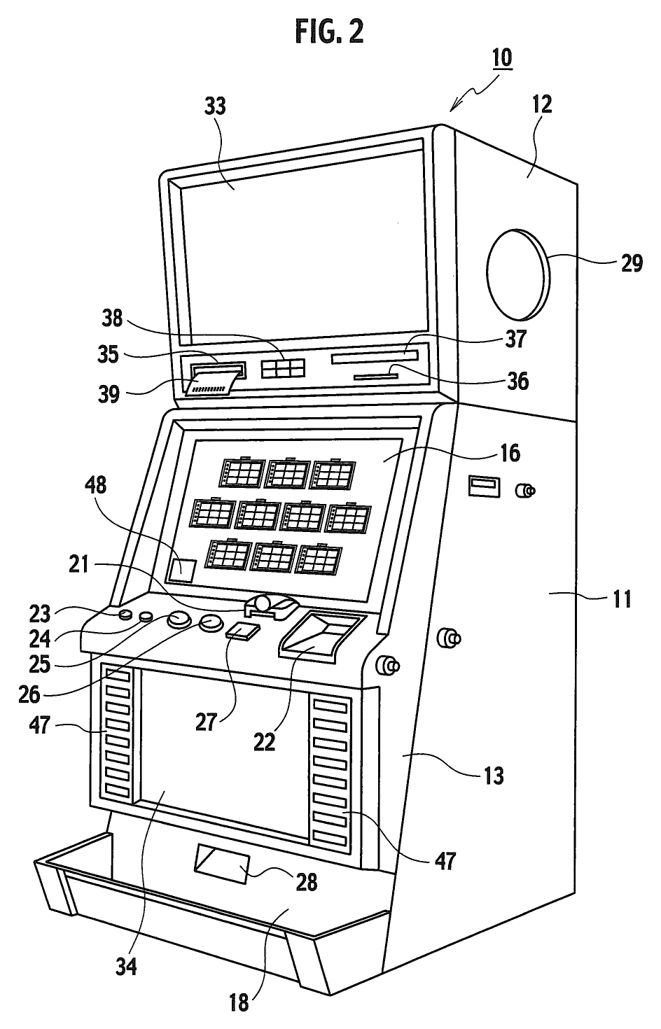

Now, characteristic features of an embodiment of the present invention will be described below with reference to a display example shown in FIG. 1 and a perspective view of a slot machine 10 shown in FIG. 2. FIG. 1 is an explanatory view showing a display example to be displayed on a liquid crystal display (a display) 16 of the slot machine 10 according to an embodiment of the present invention. As shown in FIG. 1, the liquid crystal display 16 is provided with ten slot game areas A1 to A10 (hereinafter simply referred to as “areas”) and a slot game is executed in each of the areas A1 to A10.

Specifically, nine display regions defined by three rows and three columns are set in each of the areas A1 to A10. Credits are bet by means of either inserting medals or pressing a BET switch 25, and symbols displayed (arranged) in the respective display regions are scrolled by pressing a start switch 27. Thereafter, a slot game is executed where the scrolled symbols stop at (are rearranged in) the respective display regions defined by three rows and three columns.

It is possible to bet credits equivalent to three medals at the maximum for a slot game executed in each of the areas A1 to A10. In each slot game, the number of paylines is increased in accordance with an increase in the number of bet credit.

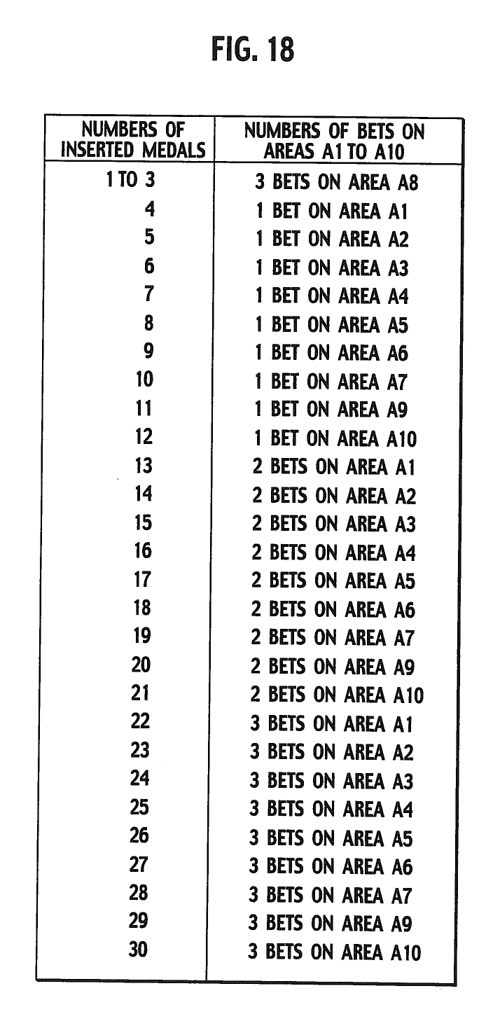

When medals are inserted from a medal insertion slot 21 (an input device) or the BET switch 25 (an input device) is pressed down (i.e. when a bet of credits is read out by the input device), credits are sequentially bet on the ten areas A1 to A10. For example, a credit equivalent to one medal is bet on the area A1 when one medal is inserted from the medal insertion slot 21, and a credit equivalent to one medal is bet on the area A2 when another medal is inserted. However, as will be described later, a credit is preferentially bet on an area where a bonus game takes place. An example of relations between the number of inserted medals and the bets is shown in FIG. 18 and details thereof will be described later.

In another embodiment, credits are randomly bet on the areas A1 to A10.

When the symbols satisfying any of the winning combinations are stopped on any of the paylines as an outcome of the slot games in the respective areas A1 to A10, a payout corresponding to this winning combination is generated. Specifically, medals in the number corresponding to this winning combination are paid out or credits in the number corresponding to this winning combination are added. For example, when symbols satisfying any of the winning combinations are stopped on paylines in some slot games executed in the areas A1 to A10, a payout in a total amount of these payouts is generated. Alternatively, a payout corresponding to the largest amount of a payout out of these payouts is generated.

Although the case of playing each slot game by scrolling the stopped symbols and then stopping the symbols again has been described above as an example, the operation of the slot game is not limited to scrolling the symbols. For example, it is also possible to change the symbols displayed (arranged) on the respective display regions individually and then to display (rearrange) new symbols.

Although the maximum number of credit to be bet is set to three medals for each of the areas A1 to A10 in the above-described example, the present invention is not limited to this configuration.

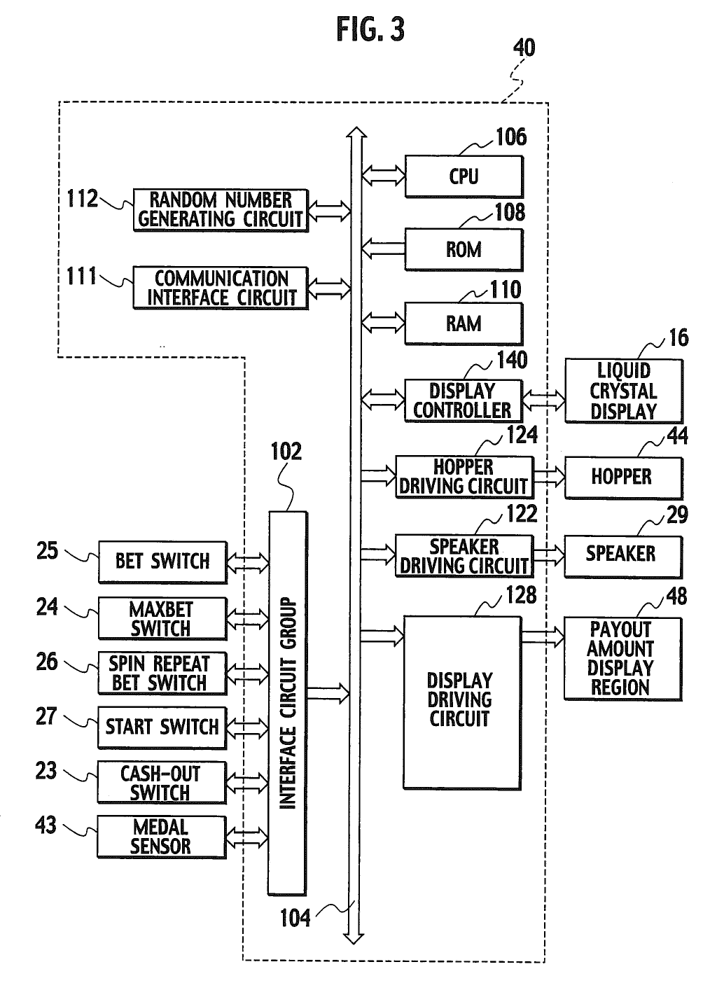

FIG. 2 is a perspective view showing the slot machine 10 according to the embodiment of the present invention. The slot machine 10 includes a cabinet 11, a top box provided on the upper side of the cabinet 11, and a main door 13. The cabinet 11 is provided with a liquid crystal display 16 on a face against a player. Various constituent components including a controller 40 (see FIG. 3) configured to electrically control the slot machine 10 and a hopper 44 (see FIG. 3) configured to control insertion, storage, and payouts of the medals are disposed inside the cabinet 11.

In this embodiment, medals are used as an example of game media used for playing the games, the game media are not limited to the medals. For example, coins, tokens, electronic money, and valuable electronic information equivalent thereto can be used.

The main door 13 is openably and closably provided on the cabinet 11, and the liquid crystal display 16 is provided near the center of this main door 13. As will be described later, the liquid crystal display 16 is provided with the ten slot game areas A1 to A10 (hereinafter simply referred to as the “areas”) and the slot games are independently executed in the respective areas A1 to A10. Although the number of the slot game areas is set to “ten” in this embodiment, the present invention is not limited to this configuration. At least two slot game areas have only to be provided.

Each of the areas A1 to A10 is provided with nine display regions defined by three rows and three columns, and various symbols are displayed in the respective display regions. Specifically, when a slot game is started, symbols displayed (arranged) in each of the display regions are scrolled and then stopped (rearranged) after a predetermined period of time. Then, a payout (an award) is generated according to the combination of the symbols stopped in each of the display regions.

A payout amount display region 48 adapted to display an amount of payout is provided in a lower left region of the liquid crystal display 16.

The medal insertion slot 21 for inserting medals used for playing the games and a bill validator 22 configured to validate whether or not bills are legitimate and to accept legitimate bills are provided below the liquid crystal display 16. Various operation switches are provided in the vicinity of the medal insertion slot 21 and the bill validator 22.

A cash-out switch 23, a MAXBET switch 24, the BET switch 25, a spin repeat bet switch 26, and the start switch 27 are provided as the operation switches.

The BET switch 25 is a switch to instruct the numbers of credits to be bet on the respective slot games each executed in the multiple slot game areas A1 to A10. As will be described later, a credit equivalent to one medal is bet on one of the slot game areas A1 to A10 every time pressing the BET switch 25. In the slot game areas A1 to A10 where the credits are bet, the executed slot games are activated and a payout is generated when the symbols satisfying the winning combination are stopped on a payline therein.

The spin repeat bet switch 26 is a switch for playing the slot games in the respective areas A1 to A10 by betting, on the respective areas A1 to A10, the same number of credits as those bet by use of the BET switch 25 in the previous game.

The start switch 27 is a switch for starting the slot games in the slot game areas A1 to A10 after betting a desired number of credits on the multiple slot game areas A1 to A10. The slot games are started in the respective areas A1 to A10 when this start switch 27 is pressed down after inserting the medals to the medal insertion slot 21 or betting credits by use of the BET switch 25.

The cash-out switch 23 is a switch for cashing out the inserted medals. The medals to be cashed out are discharged from a medal payout opening 28 provided at a lower part on the front face of the main door 13. The discharged medals are pooled in a medal tray 18.

The MAXBET switch 24 is a switch for betting the maximum number of credits that the player can bet in one game session (for example, credits corresponding to thirty medals) in a single operation.

A foot display 34 is provided on the lower part of the front face of the main door 13 and is adapted to display various images related to the games run on the slot machine 10. The images include characters of the slot machine 10, for example.

Lamps 47 are provided on both sides of the foot display 34 and are lit according to illumination patterns each preset for each of the play conditions on the slot machine 10. The medal payout opening 28 is provided below the foot display 34.

An upper display 33 is provided on the front face of the top box 12. The upper display 33 includes a display panel which displays information including each of the numbers of medals to be paid out for each of the combinations of the symbols.

The top box 12 is provided with a speaker 29. A ticket printer 35, a card reader 36, a data display 37, and a keypad 38 are provided below the upper display 33. The ticket printer 35 prints a bar-code on a ticket, the bar-code having coded data such as the number of credits, time and date, and an identification number of the slot machine 10, and outputs the ticket as the bar-coded ticket 39.

The player can play other slot machines by having the bar-coded ticket 39 read by the slot machines or change the bar-coded ticket 39 for bills and the like at a predetermined location in the game arcade (such as a cashier in a casino).

The card reader 36 is a reader into which a smart card can be inserted and is configured to read data from the inserted smart card and to write data into the smart card. The smart card is a card carried by the player, and stores data for identifying the player, data on a history of games played by the player, and so forth.

FIG. 3 is a block diagram showing a controller 40 provided in the slot machine 10 of this embodiment and electrical configurations of various devices to be connected to this controller 40. The controller 40 of the slot machine 10 shown in FIG. 3 is a microcomputer which includes an interface circuit group 102, an input-output bus 104, a central processing unit (CPU) 106, a read-only memory (ROM) 108, a random access memory (RAM) 110, a communication interface circuit 111, a random number generating circuit 112, a speaker driving circuit 122, a hopper driving circuit 124, a display driving circuit 128, and a display controller 140.

The interface circuit group 102 is connected to the input-output bus 104 and this input-output bus 104 inputs and outputs data signals and address signals to and from the CPU 106.

The star switch 27 is connected to the interface circuit group 102. A start signal outputted from this start switch is converted into a given signal by the interface circuit group 102 and is then transmitted to the CPU 106 through the input-output bus 104.

The BET switch 25, the MAXBET switch 24, the spin repeat bet switch 26, and the cash-out switch 23 are connected to the interface circuit group 102. Moreover, respective switching signals outputted from these switches 25, 24, 26, and 23 are supplied to the interface circuit group 102, then converted into predetermined signals by this interface circuit group 102, and then transmitted to the CPU 106 through the input-output bus 104.

In addition, a medal sensor 43 is connected to the interface circuit group 102. The medal sensor 43 is a sensor for detecting medals inserted from the medal insertion slot 21, and is provided at a medal insertion region of the medal insertion slot 21. A detection signal outputted from this medal sensor 43 is supplied to the interface circuit group 102, then converted into a predetermined signal by this interface circuit group 102, and then transmitted to the CPU 106 through the input-output bus 104.

The ROM 108 storing system programs and the RAM 110 for saving various data are connected to the input-output bus 104. Moreover, the random number generating circuit 112, the communication interface circuit 111, the display controller 140, the hopper driving circuit 124, the speaker driving circuit 122, and the display driving circuit 128 are connected to the input-output bus 104.

When an operation to start a game is accepted by the start switch 27, the acceptance triggers the CPU 106 to read out a game execution program to execute games. The game execution program is a program to execute, by way of the display controller 140, slot games in the respective areas A1 to A10 provided on the liquid crystal display 16.

Specifically, the game execution program is programmed to execute a slot game by scrolling the symbols in the respective areas A1 to A10, then stopping the symbols, and generating a payout when the symbols satisfying any of the winning combinations are lined up on any of the activated paylines.

The communication interface circuit 111 is connected to an arcade server (hall server), for example, and transmits data such as a play history on the slot machine 10 to the arcade server. Meanwhile, the communication interface circuit 111 receives various data transmitted from the arcade server.

The random number generating circuit 112 generates random numbers for determining whether or not to generate winning combinations in the activated slot games executed in the respective areas A1 to A10.

The display driving circuit 128 performs control to display an amount of payout on the payout amount display region 48 defined in the lower left region of the liquid crystal display 16.

The speaker driving circuit 122 output sound data to the speaker 29. Specifically, the CPU 106 read the sound data stored in the ROM 108 and transmits the sound data to the speaker driving circuit 122 through the input-output bus 104. In this way, predetermined sound effects are outputted from the speaker 29.

The hopper driving circuit 124 outputs a payout signal to the hopper 44 when a cash-out becomes effective. Specifically, when a cash-out signal is inputted from the cash-out switch 23, the CPU 106 outputs a driving signal to the hopper driving circuit 124 through the input-output bus 104. Accordingly, the hopper 44 pays out the medals equivalent to the number of credits, which are stored in a predetermined memory region of the RAM 110, remaining at that time.

The display controller 140 performs display control for executing the slot game in each of the multiple areas A1 to A10 provided on the liquid crystal display 16. Specifically, the CPU 106 generates image display instruction signals corresponding to either states or outcomes of the slot games executed in the respective areas A1 to A10 and outputs the image display instruction signals to the display controller 140 through the input-output bus 104. When the image display instruction signals outputted from the CPU 106 are inputted to the display controller 140, the display controller 140 generates driving signals for driving the liquid crystal display 16 based on the image display instruction signals and outputs the generated driving signals to the liquid crystal display 16. In this way, predetermined images are displayed on the liquid crystal display 16.

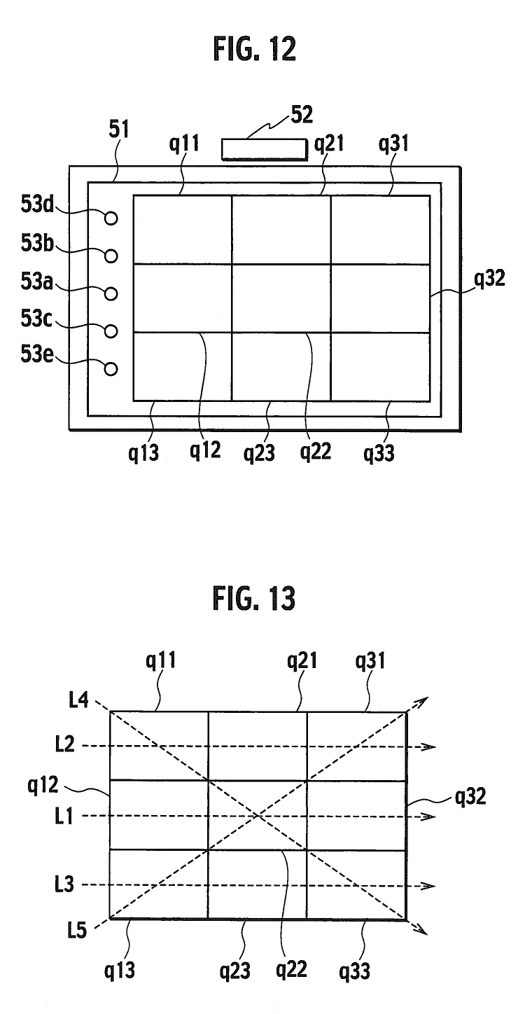

Next, the images to be displayed on each of the slot game areas A1 to A10 will be described with reference to FIG. 12. FIG. 12 is a display example in the areas A1 to A10.

As shown in FIG. 12, each of the areas A1 to A10 is provided with nine display regions q11 to q33 defined by three rows and three columns. When a slot game is executed, various symbols are scroll-displayed on these nine display regions q11 to q33.

Five light emitting diodes (LEDs) 53a to 53e are provided on the left side of the display regions q11 to q33. The number of the LEDs 53a to 53e to be turned on is determined in accordance with the number of bet credit. To be more precise, the LED 53a is turned on when a credit equivalent to one medal is bet on this slot game area. The LEDs 53b and 53c are turned on in addition to the LED 53a when credits equivalent to two medals are bet on this slot game. The LEDs 53d and 53e are turned on in addition to the LEDs 53a to 53c when credits equivalent to three medals are bet on this slot game.

The respective LEDs 53a to 53e are provided in order to notify paylines in this slot game area. FIG. 13 is an explanatory view showing paylines in the slot game area. Among the nine display regions q11 to q33 defined by three rows and three columns, a horizontal line in the center is defined as a line L1, an upper horizontal line is defined as a line L2, and a lower horizontal line is defined as a line L3. Further, a diagonal line from lower-left to upper-right is defined as a line L4 while a diagonal line from upper-left to lower-right is defined as a line L5.

Moreover, the line L1 is set as a payline when the LED 53a shown in FIG. 12 is turned on and the lines L2 and L3 are set as paylines when the LEDs 53b and 53c are turned on. In addition, the lines L4 and L5 are set as paylines when the LEDs 53d and 53e are turned on. Therefore, only the line L1 is set as a payline when a credit equivalent to one medal is bet and the lines L1, L2, and L3 are set as paylines when credits equivalent to two medals are bet. Meanwhile, all the lines L1 to L5 are set as paylines when credits equivalent to three medals are bet. Further, when the symbols satisfying winning combinations are stopped on any of these paylines set in the above-described manner, a payout corresponding to the winning combination is generated.

An activated area notification frame is provided around the display regions q11 to q33. This activated area notification frame 51 is turned on when the slot game area is activated. The activated area notification frame 51 of a slot game area is turned on when at least a credit equivalent to one medal is bet on this slot game area. In this way, a player can easily find out the activated areas among the ten areas A1 to A10.

A bonus notifier 52 is provided above the display regions q11 to q33. This bonus notifier 52 is turned on when a bonus game (to be described later) is executed in the slot game executed in this slot game area. The player can easily find out the area where the bonus game is executed by watching the bonus notifiers 52.

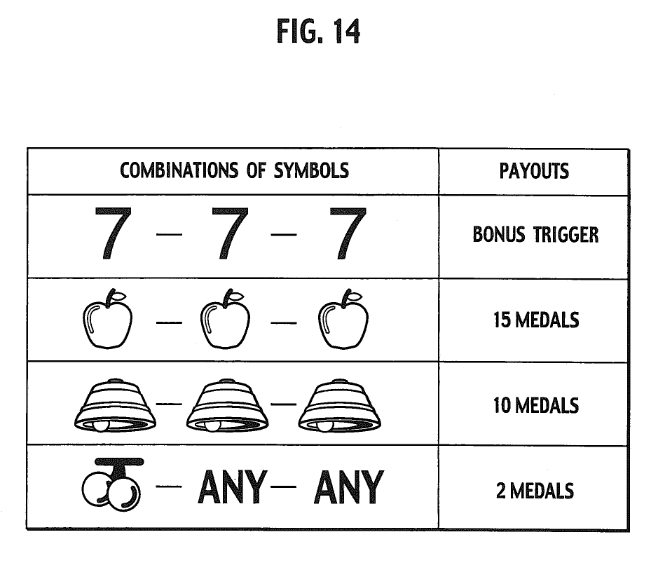

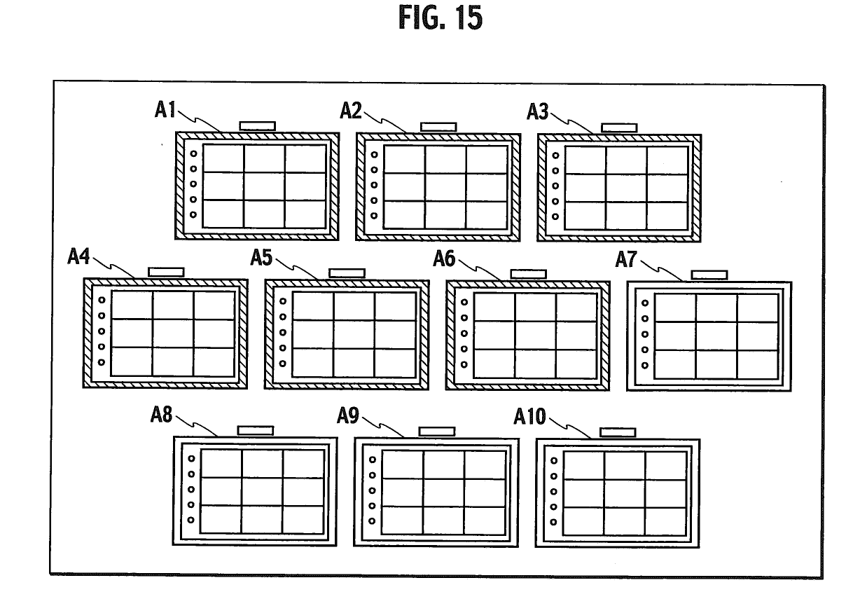

FIG. 14 is an explanatory view showing arrangement of symbols constituting the winning combinations. As shown in FIG. 14, a bonus game is started when “7” symbols are lined up on the payline, or in other words, when three “7” symbols are lined up on the line L1 in the case where the line L1 shown in FIG. 13 is set to a payline. Meanwhile, a payout equivalent to fifteen medals is generated when “APPLE” symbols are lined up. Likewise, a payout equivalent to ten medals is generated when “BELL” symbols are lined up and a payout equivalent to two medals is generated when a “CHERRY” symbol is stopped on any of the display regions on the left side.

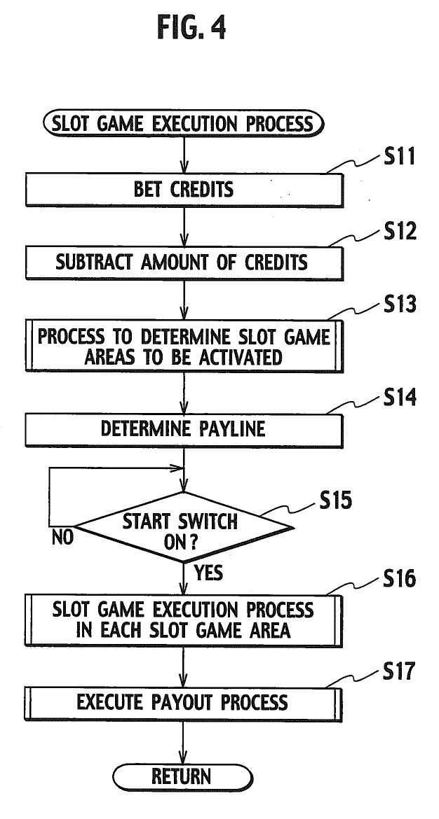

Next, actions of the slot machine of this embodiment will be described with reference to flowcharts shown in FIG. 4 to FIG. 11. FIG. 4 is a flowchart showing procedures of an execution process of the slot game.

First, the player presses the BET switch 25 and bets a desired number of credits (Step S11). Alternatively, the player inserts a desired number of medals to the medal insertion slot 21 and bet credits equivalent to the number of inserted medals. The CPU 106 shown in FIG. 3 subtracts the number of credits bet by pressing the BET switch 25 from a current number of credits (Step S12). For example, if the player bets equivalent to “thirty” credits when the current number of credits is equal to “fifty”, then the thirty credits are subtracted from the current credits and the remaining number of credits becomes equal to “twenty”.

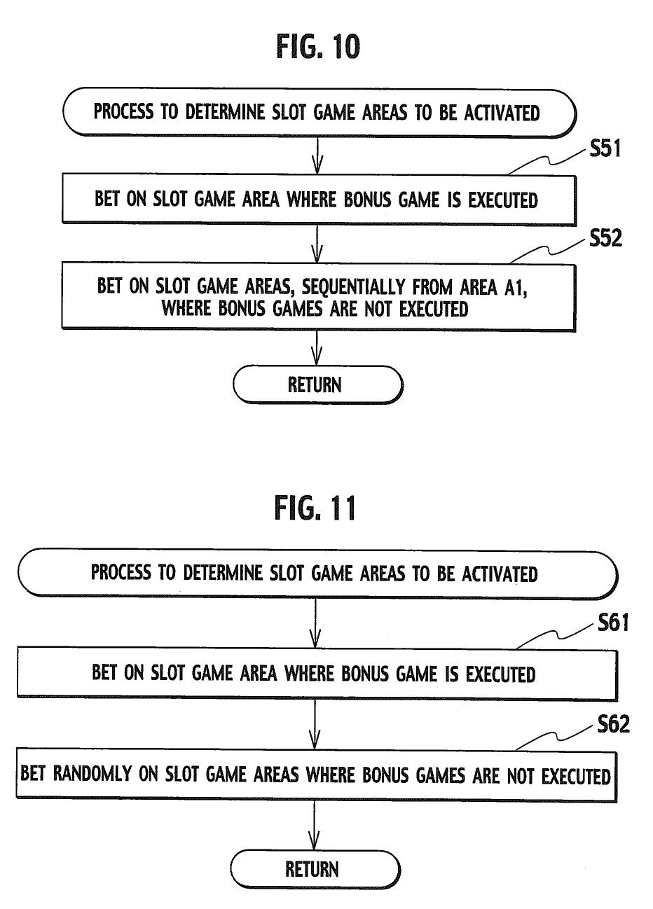

Subsequently, the CPU 106 determines the areas to be activated among the ten slot game areas A1 to A10 (Step S13). Details of this process will be described later with reference to FIG. 10 and FIG. 11.

After completing the process to determine the activated areas, the CPU 106 determines paylines in the activated areas (Step S14). As described previously, the line L1 shown in FIG. 13 is activated when a credit equivalent to one medal is bet in one area. The lines L1, L2, and L3 are activated when the credits equivalent to two medals are bet in one area, and all the lines L1 to L5 are activated when the credits equivalent to three medals are bet in one area. Among the activated area notification frames 51 provided around the areas A1 to A10, the activated area notification frames 51 provided around the areas on which credits are bet are turned on so as to notify the player of which areas are activated.

When the areas A1 to A6 are activated, for example, the activated area notification frames 51 for the areas A1 to A6 are turned on whereas the activated area notification frames 51 for the areas A7 to A10, which are not activated, are not turned on, as shown in FIG. 15.

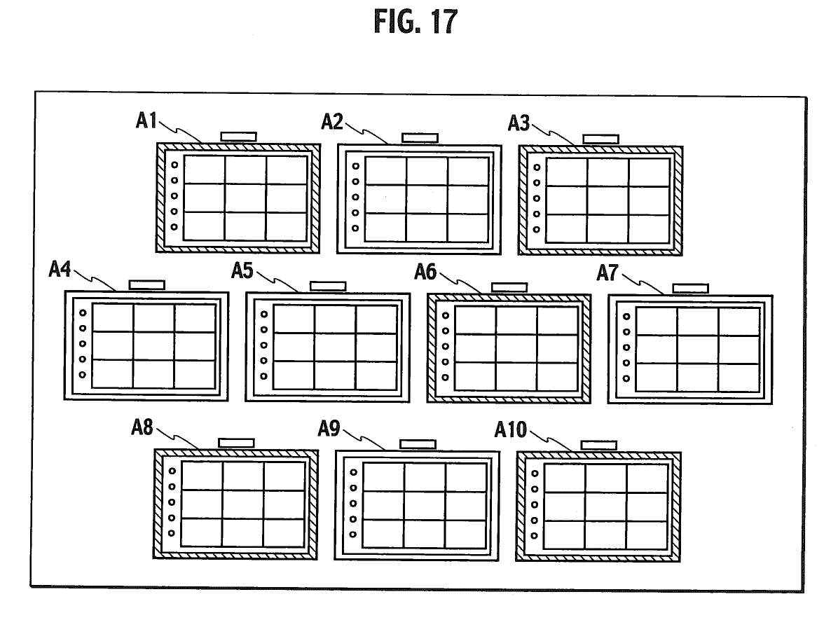

In addition, as will be described later, credits are not always bet on the areas A1 to A10 sequentially in the case of randomly betting on the areas A1 to A10. Therefore, the areas A1, A3, A6, A8, and A10 may be activated as shown in FIG. 17, for example, and the activated area notification frames 51 for those areas may be turned in that case.

Thereafter, the CPU 106 judges whether or not the start switch 27 is turned on (Step S15). When the start switch 27 is turned on, the CPU 106 executes the slot games in the activated areas out of the areas A1 to A10 (Step S16).

When the slot games in the respective areas A1 to A10 are completed, the CPU 106 executes a payout process for the payouts generated in these areas (Step S17).

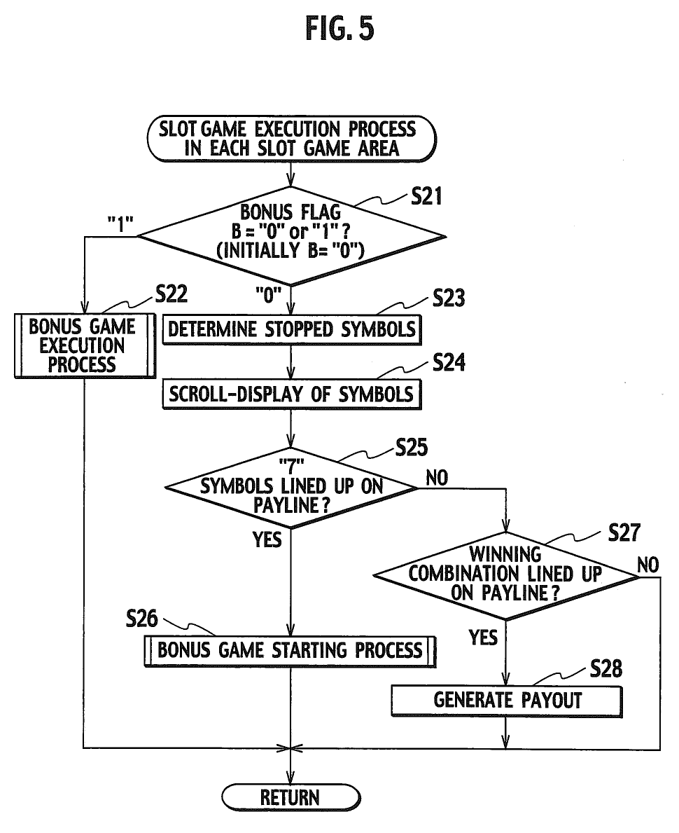

Next, procedures of the slot game to be executed in each of the areas A1 to A10 will be described with reference to FIG. 5. Here, the slot game to be executed in the area A1 will be described as a representative example.

First, the CPU 106 judges whether a bonus flag in the area A1 is “0” or “1” (Step S21). The bonus flag is initially set to “0”, and is set to “1” when the bonus game is executed.

Subsequently, the CPU 106 determines which symbols to be stopped in the respective display regions q11 to q33 (Step S23). The symbol (such as “7”, “BELL” or “APPLE”) to be displayed on each of the display regions q11 to q33 is determined.

Thereafter, the CPU 106 scrolls the symbols in the display regions q11 to q33 (Step S24). Then, after a predetermined period of time, a symbol is stopped in each of the display regions q11 to q33. Here, the symbols determined in Step S23 are displayed in the display regions.

Then, the CPU 106 judges whether or not the “7” symbols are lined up, or whether or not the combination indicating a bonus trigger is displayed, on any of the paylines (Step S25). For example, when all the five lines L1 to L5 shown in FIG. 13 are set as paylines, the CPU 106 judges whether or not the “7” symbols are lined up on any of the paylines L1 to L5.

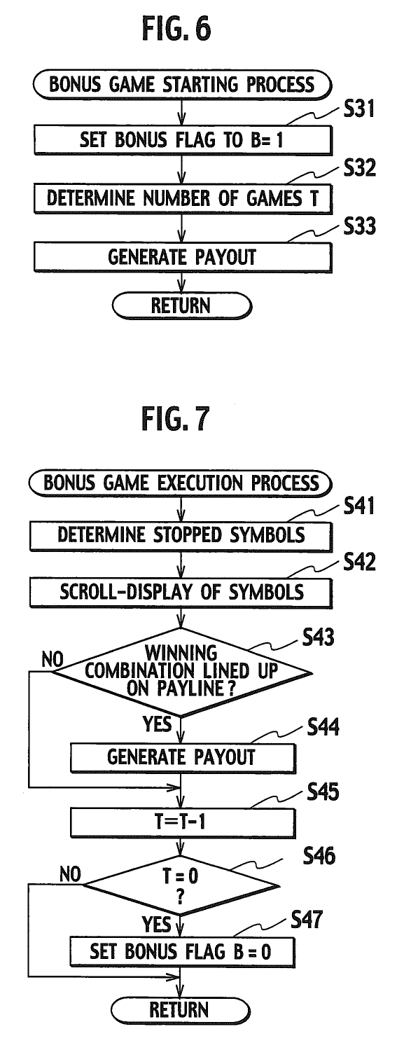

Thereafter, the bonus trigger becomes activated when the “7” symbols are lined up on any of the paylines L1 to L5. Therefore, the CPU 106 executes a bonus game starting process (Step S26). This bonus game starting process will be described later with reference to FIG. 6.

Meanwhile, when the “7” symbols are not lined up on any of the paylines, the CPU 106 judges whether or not the symbols satisfying any of the winning combinations are displayed on any of the paylines (Step S27). If the symbols satisfying any of the winning combinations are displayed, a payout in an amount corresponding to the displayed winning combination is generated (Step S28). On the other hand, the CPU 106 does not generate a payout if the symbols satisfying any of the winning combinations are not displayed on any of the paylines and terminates the slot game in this area A1 instead.

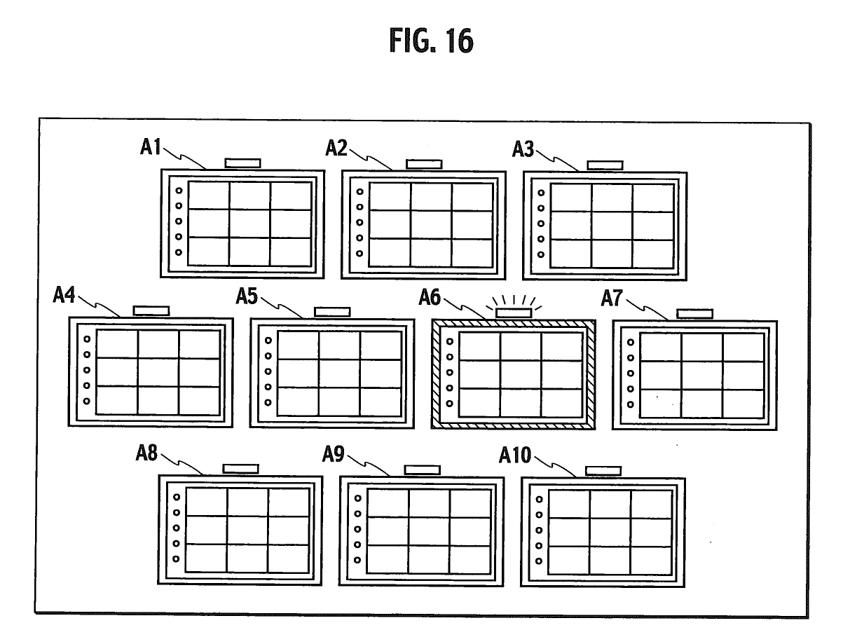

Next, procedures of the bonus game starting process will be described with reference to a flowchart shown in FIG. 6. The bonus flag is set to “1” (Step S31 in FIG. 6) when the “7” symbols are lined up on any of the paylines so that the bonus trigger becomes activated in the procedure in Step S25 of FIG. 5. At this time, the bonus notifier 52 for the area A1 shown in FIG. 12 is turned on so as to notify the player that the bonus game is executed in the area A1. For example, when the bonus game is executed in the area A6, the bonus notifier 52 for the area A6 is turned on as shown in FIG. 16.

Thereafter, the CPU 106 determines the number of bonus games T (Step S32). The number of bonus games T is set to fifty, for example. This number of bonus games may either be set as a fixed number or be determined randomly by the CPU 106 each time a bonus game is executed. The number of bonus games “T” is stored in the RAM 110.

Subsequently, a payout for the bonus trigger is generated (Step S33). For example, a payout equivalent to fifteen medals is generated. Then, this process is terminated.

When the bonus flag is set to “1” in the bonus game starting process shown in FIG. 6, the bonus flag is set to “1” in the next slot game in the area A1. Accordingly, in the next slot game in the area A1 at Step 21 in FIG. 5 results in “1” so that the bonus game execution process is carried out (Step S22).

Now, the bonus game execution process will be described below with reference to a flowchart shown in FIG. 7. When the bonus game is executed, the CPU 106 performs a process to determine the symbols to be stopped (Step S41). This process is similar to the process in Step S23 shown in FIG. 5. However, in the process in Step S41 settings are made such that the “7” symbols are not lined up on a payline and that the winning combinations are satisfied at a higher probability. That is, in a bonus game, the symbols such as “BELL”, “APPLE” or “CHERRY” shown in FIG. 14 are more likely to be lined up on a payline than a basic game.

Subsequently, the CPU 106 starts scrolling the symbols (Step S429. This procedure is similar to Step S24 in FIG. 5.

Then, the CPU 106 judges whether or not the symbols satisfying any of the winning combinations are displayed on any of the paylines (Step S43). If the symbols satisfying the winning combination are displayed, a payout in an amount corresponding to the displayed winning combination is generated (Step S44). On the other hand, the CPU 106 does not generate a payout if the symbols satisfying any of the winning combinations are not displayed on any of the paylines.

Thereafter, the CPU 106 decrements the number of bonus games stored in the RAM 110 from “T” to “T-1” (Step S45).

The CPU 106 judges whether or not the number of bonus games “T” stored in the RAM 110 satisfies “T=0” (Step S46). When “T=0” holds true, the CPU 106 turns the bonus flag to “0” (Step S47). That is, when the predetermined sessions of bonus games are consumed, the CPU 106 sets the bonus flag to “0” and thereby terminates the bonus games.

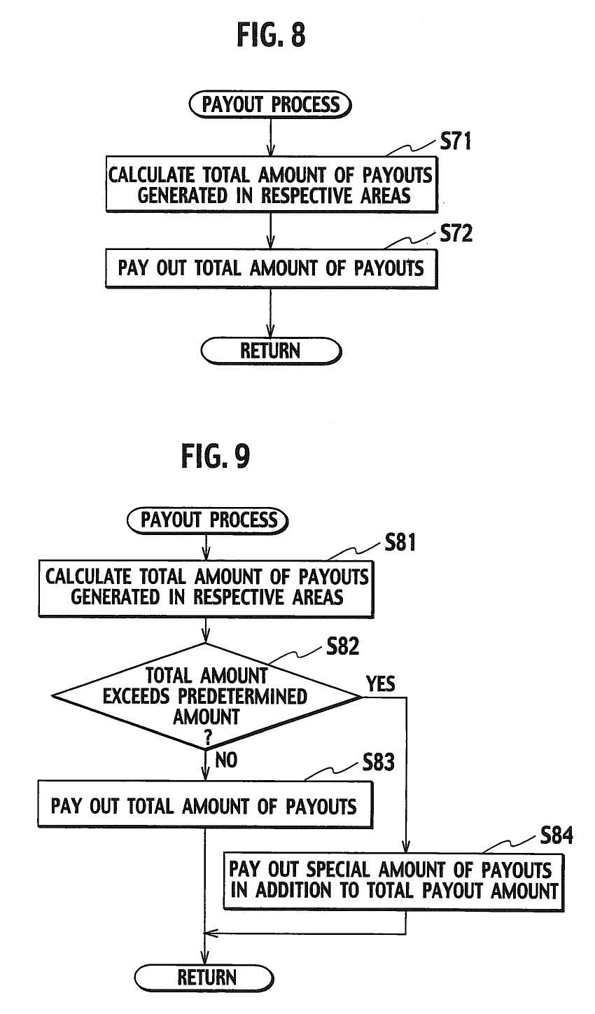

Next, the payout process shown in Step S17 in FIG. 4 will be described with reference to a flowchart shown in FIG. 8.

In this process, the CPU 106 calculates a total amount of the payouts generated as outcomes of the slot games executed in the respective areas A1 to A10 (Step S71). For example, if the payouts equivalent to “fifteen medals” are generated in two areas and the payouts equivalent to “ten medals” are generated in three areas, then a sum of these amounts equal to sixty medals are calculated as a total amount of the payouts.

Then, the medals in the amount equivalent to the total amount of the payouts are paid out (Step S72). Here, when the payout is generated, the medals equivalent to this payout may be paid out of the payout opening 28 or the credits equivalent to this payout may be added to the current number of credits.

FIG. 9 is a flowchart showing another example of the payout process. In this process, the CPU 106 calculates total amount of the payouts generated as outcomes of the slot games executed in the respective areas A1 to A10 (Step 81). Subsequently, the CPU judges whether or not total amount of the payouts exceeds a predetermined amount (Step S82).

When total amount of the payouts does not exceed the predetermined amount (NO in Step S82), the total payout amount is paid out (Step S83). On the contrary, when total amount of the payouts exceeds the predetermined amount (YES in Step S82), an amount obtained by adding a special payout amount to this total amount of the payouts is paid out (Step S84).

For example, the following conditions are assumed: the predetermined amount is set to “50”; the special payout amount is set to “20”; and the total amount of the payouts is equal to “60”. Here, since the total amount of the payouts “60” is greater than the predetermined amount “50”, the special amount “20” is added to the total amount of the payouts “60” whereby eighty medals are paid out in total. In other words, eighty medals may be paid out or the credits equivalent to eighty medals are added to the current number of credits.

Meanwhile, if the total amount of the payouts is equal to “40”, the total amount of the payouts “40” is smaller than the predetermined amount “50”. In this case, forty medals are paid out without addition of the special payout amount.

Next, a process to determined the slot game areas to be activated will be described with reference to a flowchart shown in FIG. 10 and a table shown in FIG. 18.

When the BET switch 25 is pressed down or the medals are inserted from the medal insertion slot 21, the CPU 106 firstly bets the credits preferentially on the areas where the bonus games are executed (Step S51). Thereafter, the credits are bet on other areas sequentially in the order of the areas A1, A2, A3, and so forth (Step S52).

For example, when the bonus game is executed in the area A8, the first to third credits are bet on the area A8, then the fourth credit is bet on the area A1, and then the fifth credit is bet on the area A2 as shown in FIG. 18. Then, the above-mentioned procedures are sequentially repeated till three credits are bet on all the areas A1 to A10 with the maximum of 30 credits.

The above case shows the example in which the area A8 is the only area where the bonus game is executed. When the bonus games are executed in two or more areas at the same time, the credits are bet preferentially on these areas where the bonus games are executed, and then the credits are bet on other areas where the bonus games are not executed.

FIG. 11 is a flowchart showing another aspect of procedures of the process to determine the slot game areas to be activated. In this process, when the BET switch 25 is pressed down, the CPU 106 firstly bets the credits preferentially on the area where the bonus game is executed as similar to the case shown in FIG. 10 (Step S61). Thereafter, the credits are bet randomly on other areas where the bonus games are not executed (Step S62). This process is performed according to arbitrary determination of the CPU 106 and the order of betting the credits is randomly determined in each game.

In this way, according to the slot machine of this embodiment, it is possible to play multiple slot games at the same time in one play session by providing the multiple slot game areas (ten areas are provided in this embodiment).

In addition, the payout is provided in accordance with the amounts of the payouts in the slot games executed in the respective areas A1 to A10. Since the total amount of the payouts is paid out, for example, it is possible to let a player be more interested in the slot games executed in the respective areas A1 to A10.

Moreover, if a configuration to add the special payout amount to the total amount of the payouts when the total amount of the payouts in the respective slot games exceeds the predetermined amount is employed, it is possible to let the player to get interested in whether or not the total amount of the payouts exceeds the predetermined amount.

Although the slot machine according to a certain embodiment of the present invention has been described above, the invention may be embodied in other specific forms without departing from the spirit or essential characteristics thereof. The present embodiment is therefore to be considered in all aspects as illustrative and not restrictive, the scope of the invention being indicated by the appended claims rather than the foregoing description and all changes which come within the meaning and range of equivalency of the claims are therefore intended to be embraced therein. Moreover, the effects described in the embodiment of the present invention merely enumerate most preferable effects arising from the present invention. It is therefore to be understood that the effects of the present invention will not be limited to the effects expressly described in the embodiment of the present invention.

For example, the foregoing embodiment has described the case where the slot games are executed in all the slot game areas irrespective of whether or not those areas are activated. Instead, it is also possible to execute the slot games only in the activated slot game areas.

Moreover, the foregoing embodiment has described the example of paying out the total amount of the payouts generated in the respective slot games as the payout generated as outcomes of the respective slot games. Instead, it is also possible to provide the largest amount of a payout out of the amounts of payouts generated in the respective slot games.

Moreover, the foregoing embodiment has described the case of providing the ten slot game areas A1 to A10 on the liquid crystal display 16, or in other words, the case of displaying the symbols used for executing the slot games in the form of images. However, the present invention is not limited to this configuration and may also be configured to employ rotatable wheels. In such a case, each of the slot game areas A1 to A10 is provided with three rotatable reels.

What is claimed is:

1. A slot machine comprising:
a display having a plurality of slot game areas for executing a slot game of rearranging a plurality of arranged symbols in each of the slot game areas;
an input device configured to read a bet of a credit by a player; and
a controller configured to activate a slot game area corresponding to the bet read by the input device out of the plurality of slot game areas, to execute the slot game in the activated slot game area, and to provide a payout corresponding to an outcome of a play of each executed slot game.

2. The slot machine according to claim 1,
wherein, when an amount of the payout corresponding to the outcome of the play of each slot game executed in the activated slot game area reaches a predetermined payout amount, the controller is configured to provide a special payout amount in addition to the predetermined payout amount.

3. A slot machine comprising:
a display having a plurality of slot game areas for playing a slot game of rearranging a plurality of arranged symbols in each of the slot game areas;
an input device configured to read a bet of a credit by a player; and
a controller configured to activate slot game areas corresponding to the bet read by the input device out of the plurality of slot game areas, and when outcomes of plays of some of the slot games out of the slot games executed in the activated slot game areas deserve provision of payouts, to provide a total amount of the payouts of the respective slot games.

4. A slot machine comprising:
a display having a plurality of slot game areas for executing a slot game by rearranging a plurality of arranged symbols in each of the slot game areas;
an input device configured to read a bet of a credit by a player; and
a controller configured to activate slot game areas corresponding to the bet read by the input device out of the plurality of slot game areas, and when outcomes of plays of some of the slot games out of the slot games executed in the activated slot gale areas deserve provision of payouts, to provide a total amount of the payouts in the respective slot games, and to provide a special payout amount in addition to the total amount of the payouts when the total amount of the payouts reaches a predetermined amount.

5. A method of playing a slot machine comprising:
making a bet of a credit;
activating a slot game area in accordance with the bet out of a plurality of slot game areas for executing a slot game of rearranging a plurality of arranged symbols in each of the slot game areas;
executing the slot game in the activated slot game area; and
providing a payout corresponding to an outcome of a play in each slot game executed in the activated slot game area.

6. The method of playing a slot machine according to claim 5, further comprising:
when an amount of the payout corresponding to the outcome of the play of each slot game executed in the activated slot game area reaches a predetermined payout amount, providing a special payout amount in addition to the predetermined payout amount.

7. A method of playing a slot machine comprising:
making a bet of an arbitrary number of credits;
activating slot game areas in accordance with the bet out of a plurality of slot game areas for executing a slot game of rearranging a plurality of arranged symbols in each of the slot game areas;
executing the slot games in the activated slot game areas; and
when outcomes of plays of some of the slot games executed in the activated slot game areas deserve provision of payouts, providing a total amount of the payouts of the respective slot games.

8. A method of playing a slot machine comprising:
making a bet of an arbitrary number of credits;
activating slot game areas in response to the bet out of a plurality of slot game areas for executing a slot game by rearranging a plurality of arranged symbols in each of the slot game areas;
executing the slot games in the activated slot game areas;
when outcomes of plays of some of the slot games executed in the activated slot game areas deserve provision of payouts, providing a total amount of the payouts of the respective slot games; and
providing a special payout amount in addition to the total amount of the payouts when the total amount of the payouts reaches a predetermined amount.
